(19) United States
(12) Patent Application Publication
(10) Pub. No.: US 2007/0222350 A1
(43) Pub. Date: Sep. 27, 2007

(54) SPARK PLUG

(75) Inventors: James D. Lykowski, Temperance, MI (US); Iryna Levina, Minneapolis, MN (US); Paul Tinwell, Fayence (FR)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc., Southfield, MI (US)

(21) Appl. No.: 11/691,288

(22) Filed: Mar. 26, 2007

Related U.S. Application Data
(60) Provisional application No. 60/785,592, filed on Mar. 24, 2006.

(51) Int. Cl. H01T 13/20

(52) U.S. Cl. 313/141

(57) ABSTRACT

A spark plug having a discharge portion formed of a metal alloy chip. The metal alloy is selected to prevent wear due to the interaction of Iridium with Calcium or Phosphorus during combustion.

### CROSS-REFERENCE TO RELATED APPLICATIONS

This application claims priority to U.S. Provisional Application Ser. No. 60/785,592, filed Mar. 24, 2006 which is incorporated herein by reference.

### BACKGROUND OF THE INVENTION

1. Technical Field

This invention is directed to spark plugs and other ignition devices used in internal combustion engines and, more particularly, to ignition devices having a high performance center electrode or a high performance firing tip attached to a center electrode.

2. Related Art

Spark plugs are well known in the industry and have long been used to initiate combustion in internal combustion engines. In general, a spark plug is a device that extends into a combustion chamber of an internal combustion engine and enables a spark to ignite a combustible mixture of air and fuel therein. A spark plug typically includes a cylindrical metal shell having external threads that screw into a portion of the engine and a hook shaped ground electrode attached thereto at a firing end of the spark plug. A cylindrical insulator is disposed partially within the metal shell and extends axially beyond the metal shell toward a firing end and also toward a terminal end. A conductive terminal is disposed within the cylindrical insulator at the terminal end of the spark plug, opposite the firing end. At the firing end, a center electrode is disposed within the insulator and projects axially out of the insulator toward the ground electrode, whereby a spark plug gap is defined between the center electrode and the ground electrode.

Spark plugs perform the basic function of igniting gases in an engine cylinder, the ignition of which creates the power stroke. Due to the very nature of an internal combustion engine, spark plugs are exposed to many extremes occurring within the engine cylinder, including high temperatures and various corrosive combustion gases, which have traditionally reduced the longevity of the spark plug. Electrical spark erosion also reduces the longevity of spark plugs and is where the electrode and in particular the firing tip or a material next to or adjacent to the firing tip erodes away during operation due to localized vaporization resulting from high arc temperatures of the electrical arc during operation of the spark plug. Spark plugs traditionally have electrodes formed from Nickel or Nickel alloys which are susceptible to electrical spark erosion.

The spark ignites the air and fuel mixture within the combustion chamber or cylinder to create high temperature combustion to power the engine. Unfortunately, the high voltage and high temperature environment within the combustion chamber can degrade the components of the spark plug. As the spark plug becomes degraded, the spark may become altered thereby degrading the quality of the spark and the resulting combustion.

While Nickel and Nickel alloys traditionally have been very resistant to corrosion, many of the replacement metals or metal alloys, which are more resistive to spark erosion than Nickel or Nickel alloys, may also be susceptible to corrosion. The most common replacement materials for Nickel or Nickel alloys have been Platinum, Iridium, or alloys thereof. As Platinum and Iridium are generally expensive, it is desirable to minimize the amount of material used to provide the spark portion. Therefore, a spark portion formed out of Platinum or Iridium or alloys thereof is typically attached to a Nickel or Nickel alloy center electrode and minimized in size.

While Platinum and Platinum alloys are very good at reducing spark erosion, they may also be susceptible to corrosion. Furthermore, Platinum and Platinum alloys when used as the spark portion may form various growth features on the spark portion. Over time these growths may eventually interfere with the spark or change the spark gap or spark profile thereby reducing the performance of the spark plug. Furthermore, as some of the combustion gases may cause corrosion of the Platinum spark portion, such corrosion may cause the spark plug gap to change and thereby reduce the performance of the spark plug. Reduced performance of spark plugs can cause engine misfire, decreased fuel economy, and reduced engine performance.

The use of high compression engines to improve fuel economy has required increased power passing through the spark plug to force the spark to jump the gap between the center electrode and ground electrode in a higher compression environment. This increased power has increased the rate of spark erosion in materials susceptible to spark erosion and more spark plug manufacturers are turning away from commonly used Nickel or Nickel alloy materials in search of materials that are highly resistant to spark erosion such as Platinum, Iridium, or alloys thereof. In operation, pulses of up to 40,000 volts are applied through the spark plug to the center electrode, thereby causing the spark to jump the gap between the center and ground electrodes. Any increase in the operating voltage of a spark plug also increases the likelihood of spark erosion and therefore reduces the longevity of the spark plug.

While Platinum, Iridium, or other precious metals and alloys thereof are less susceptible to spark erosion, if too small of a piece, either in length, width, or size is used for the precious metal firing tip, the spark may jump around the precious firing tip and arc between the base material of the center electrode and the ground electrode. As the base material is typically a Nickel alloy, it is susceptible to spark erosion which may cause the base material or center electrode to erode away until the precious metal firing tip falls off. Any degradation of the plug will affect the quality of the spark and any spark that does not originate from the spark surface on the spark portion but instead originates on the center electrode and passes around the precious metal firing tip will degrade the quality of the spark. The quality of the spark effects the ignition of the mixture of air and fuel (i.e., the combustion efficiency, combustion temperature, and combustion products) thus, the power output, fuel efficiency, performance of the engine, and the emissions produced by the combustion of the air and fuel mixture may be adversely affected. Due to the increasing emphasis on regulating emissions for motor vehicles, increasing fuel prices, and modern performance demands it is desirable to maintain a high quality spark for consistent engine performance and emission quality.

The longevity of the spark plug and thereby resistance of the spark plug to spark erosion is also important to manufacturers. Manufacturers are increasingly requiring longer service lifetimes from spark plugs such as 100,000 mile, 150,000 mile, and 175,000 mile service lifetimes. Many traditional Nickel spark plugs only have service lifetimes of 20,000 to 40,000 miles due to spark erosion and corrosion. One method to combat spark erosion is to significantly increase the amount of precious metal material such as Iridium, Platinum, or alloys thereof forming the tip spark portion or size of the firing tip. However, Iridium, Platinum, and alloys thereof are extremely expensive and as manufacturers continually demand cost reductions, it becomes important to minimize the amount of Iridium, Platinum, or alloys thereof used in spark plugs. Therefore, a spark portion formed out of Platinum or Iridium or alloys thereof is typically attached to a Nickel or Nickel alloy center electrode and minimized in size.

To improve performance of spark plugs and prevent growth of various materials on the spark portion of the spark plug, many manufacturers of spark plugs have recently been switching to Iridium as the discharge or spark portion. As Iridium has a very high melting point, it is highly resistant to spark erosion and is also highly resistant to oxidation and other corrosion. However, as vehicle manufacturers increase compression and operating temperatures of engines to improve fuel economy, it has been found that Iridium has a very volatile oxidation state at high temperatures, such as the upper end of the operating range of the spark plug. As higher compression engines require more power to be supplied through the plug to force the spark to jump the gap between the center electrode and ground electrode, the operational temperature of the spark plugs has been increasing. At high temperatures an Iridium spark portion of a spark plug is known to experience severe corrosion.

Iridium is also believed to experience corrosion in the presence of Calcium and/or Phosphorus, which is enhanced at high temperatures. The increased presence of Calcium and Phosphorus in combustion materials is a relatively more recent development as engine manufacturers attempt to reduce friction to increase fuel economy by allowing more oil to seep into the combustion chamber. Calcium and Phosphorus are primarily present in engine oils and, in particular, oil additives. It is believed that Calcium and Phosphorus in the presence of oxygen during combustion within the engine cylinder react with the Iridium to form a volatile compound that evaporates and results in the loss of Iridium in the spark portion. More specifically, it is believed that gaseous Calcium during the combustion and exhaust cycle condenses on the Iridium spark portion of the spark plug and, in particular, the sides of the spark portion. It is known that molten Calcium dissolves Iridium and that Iridium is vulnerable to oxidation in the presence of Phosphorus. Therefore, the compound formed after the Phosphorus and oxygen react with the dissolved Calcium Iridium mixture is very volatile and subject to evaporation which results in loss of the Iridium spark portion. A diagram of a spark plug showing the loss of a portion of the spark portion is shown in FIG. 1. It should also be noted that Iridium may also experience some oxidation without the presence of Calcium and Phosphorus in the temperature range of about 800 to 1100° C. and with the presence of Calcium and Phosphorus the above described corrosion process may occur as low as 600° C., which is within the typical operating range of a spark plug. Of course, as engine compression increases, the temperature operating range of a spark plug will increase and oxidation of Iridium even without the presence of Calcium and Phosphorus will increasingly become a problem.

### SUMMARY OF THE INVENTION

In view of the above, the present invention is directed to a spark plug having a discharge portion or firing tip formed of a firing tip that is wear resistant, corrosion resistant, erosion resistant, and has increased longevity.

The spark plug includes a firing tip having a discharge end and a weld end. The weld end is connected to the center electrode, and more specifically to a base electrode on the center electrode.

The alloy of the firing tip is generally formed with at least one element of the group consisting of Platinum, Palladium, Rhodium, Iridium, Ruthenium, and Rhenium, and at least one element selected from the group consisting of Cobalt, Chromium, Vanadium, Tantalum, and Zirconium. In some embodiments the alloy firing tip may also include Nickel and/or Tungsten. The firing tip is more particularly formed from a predominant amount of at least one element selected from the group consisting of Platinum, Palladium, Rhodium, Iridium, Ruthenium, and Rhenium, and more preferably from a predominant amount of Iridium.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 illustrates an Iridium electrode that has been eroded away;

FIG. 2 is a partial sectional view of a spark plug;

FIG. 3 is an elevational view of an electrode having an alloy firing tip;

FIG. 4 is an elevational view of an electrode having an alloy firing tip;

FIG. 5 is an elevational view of an alternative electrode having an alloy firing tip;

FIG. 6 is a second alternative view of an electrode having an alloy firing tip; and

FIG. 7 is a partial sectional view of an alternative spark plug including an alloy firing tip on both the center electrode and ground electrode.

### DETAILED DESCRIPTION OF THE PREFERRED EMBODIMENT

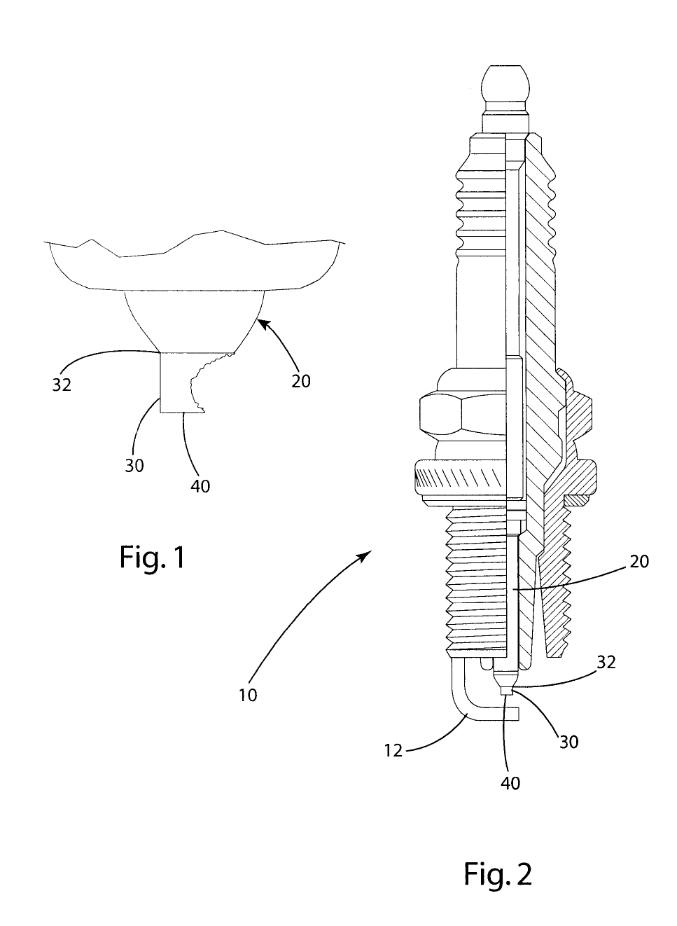

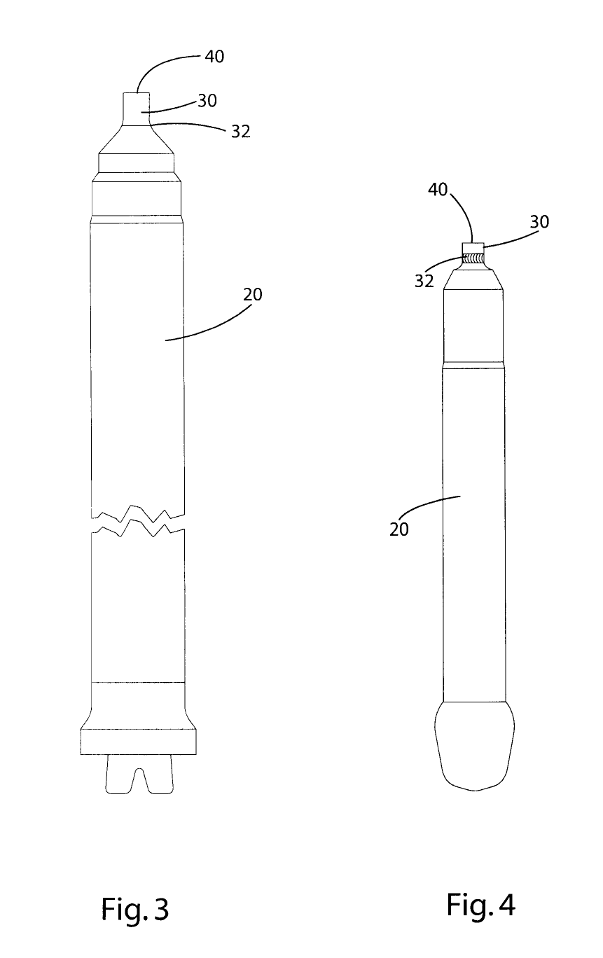

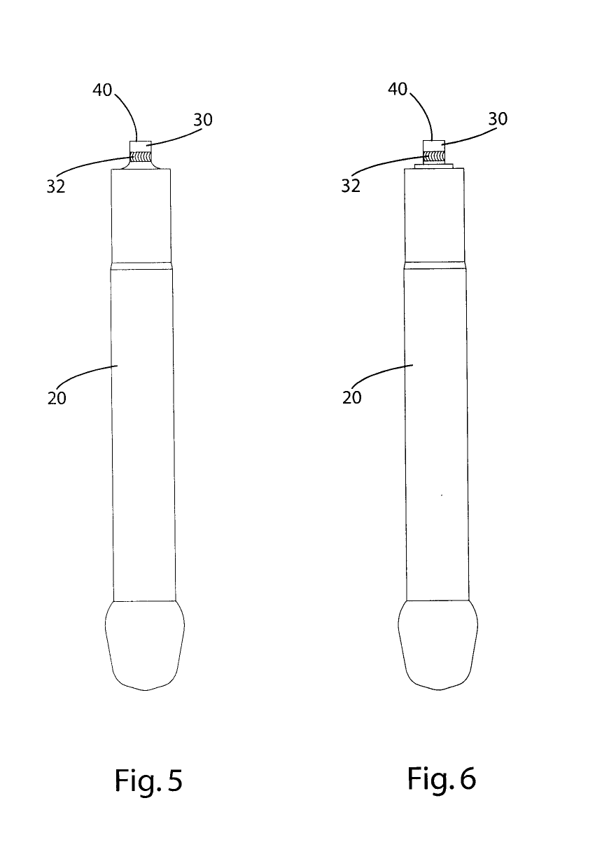

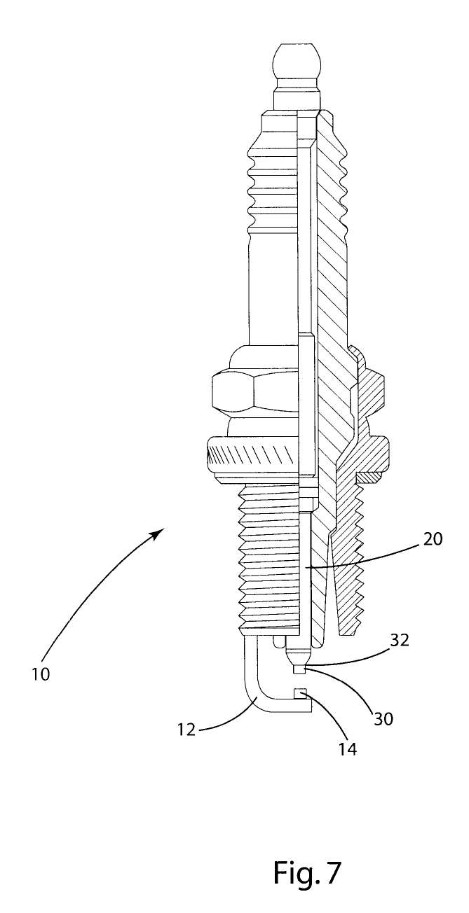

The present invention as illustrated in the figures is directed to a spark plug 10 (FIGS. 1 and 2) having a ground electrode 12 and a center electrode 20. The center electrode 20 and/or the ground electrode 12 has a firing tip 30 bonded, welded, or otherwise attached to the center electrode 20. The firing tip 30 includes a discharge surface 40 from which the spark goes between the discharge surface 40 and the ground electrode 12. As illustrated in FIG. 7, the ground electrode may also include a firing tip 14.

The firing tip 30 and/or 14 is primarily formed from at least one element selected from the group consisting of Iridium (Ir), Platinum (Pt), Palladium (Pd), Rhodium (Rh), Ruthenium (Ru), and Rhenium (Re). More particularly, the firing tip 30 is primarily formed from Iridium and may include at least one element of Platinum, Palladium, Rhodium, Ruthenium, and Rhenium. As Platinum, Palladium, Rhodium, Ruthenium, and Rhenium are elements or alloys that are highly resistant to spark erosion, the firing tip may be formed from these elements. The alloy forming the firing tip includes at least one other element selected from the group consisting of Cobalt (Co), Chromium (Cr), Vanadium (V), Tantalum (Ta), and Zirconium (Zr). The alloy may also include at least one of Nickel (Ni) and Tungsten (W). In the preferred embodiment, Iridium forms the bulk of the firing tip however, any element from the group consisting of Platinum, Palladium, Rhodium, Ruthenium, and Rhenium may be substituted. Spark plugs with a firing tip 30 having approximately 50% to 98% and more particularly approximately 95% by weight Iridium or Platinum, preferably Iridium, with the balance of material including at least one element selected from the group consisting of Cobalt, Chromium, Vanadium, Tantalum, and Zirconium provide good wear resistance, longevity, and resistance to erosion and corrosion. While the present invention contemplates Iridium, Platinum, an Iridium alloy, or a Platinum alloy as the base material of the alloy firing tip 30, the present invention is not constrained only to the use of Iridium or Platinum, or alloys thereof, as the base material. If Iridium is the predominant material, to enhance corrosion protection, at least one element selected from the group consisting of Platinum, Cobalt, Chromium, Vanadium, Tantalum, and Zirconium is included. This alloy may also include at least one of Nickel and Tungsten. However, if the firing tip 30 is predominantly formed from Platinum, then the firing tip includes at least one element selected from the group consisting of Iridium, Cobalt, Chromium, Vanadium, Tantalum, and Zirconium. Nickel and Tungsten may also be added. The at least one element added (to the firing tip predominantly formed from at least one element selected from the group consisting of Iridium, Platinum, Palladium, Rhodium, Ruthenium, and Rhenium), is generally added in an amount up to approximately 40% and more preferably up to 20%. These elements may also be added individually or in various combinations.

The materials chosen to be added to the elements selected from the group of Iridium, Platinum, Palladium, Rhodium, Ruthenium, and Rhenium, or combinations thereof, must have a good work function. More specifically, the elements to be added must form an alloy that allows for easy sparking between the firing tip 30 and the ground electrode 12. This insures that the sparking is concentrated from the firing tip 30 and not jumping around the firing tip 30 to spark between the Nickel portion of the center electrode to the ground electrode. Therefore, it is desirable for the elements to be added to have good corrosion resistance in the combustion chamber as well as good work function. Elements that fulfill the above qualities include, but are not limited to, Cobalt, Chromium, Vanadium, Tantalum, Zirconium, Tungsten, Platinum, Iridium, and Nickel. While the inventors have found the above elements to provide these characteristics, by no means is this an exhaustive list and other elements having these characteristics may be added to the alloy forming the firing tip 30 to improve the performance of the spark plug.

It has been found that the following elements provide sufficient protection against corrosion, sufficient durability, and sufficient work function when added to Iridium or Platinum. These elements or alloys include (1) Platinum, if the predominate material of the firing tip is Iridium, (2) Iridium, if the predominate material of the firing tip is Platinum, (3) Cobalt, (4) Tantalum, (5) Chromium, (6) Nickel and Cobalt, (7) Nickel and Chromium, (8) Nickel and Platinum, if the predominate material of the firing tip is Iridium, (9) Nickel and Iridium, if the predominate material of the firing tip is Platinum, (10) Nickel and Tantalum, (11) Nickel, Cobalt, and Chromium, (12) Nickel, Cobalt, and Iridium, (13) Nickel, Cobalt, and Platinum, (14) Nickel, Cobalt, Tantalum, (15) Nickel, Chromium, and Iridium, (16) Nickel, Chromium, and Platinum, (17) Nickel, Chromium, and Tantalum, (18) Nickel, Platinum, and Tantalum, (19) Nickel, Iridium, and Tantalum, (20) Nickel, Chromium, Platinum, and Cobalt, (21) Nickel, Chromium, Platinum, and Tantalum, (22) Nickel, Chromium, Iridium, and Cobalt, (23) Nickel, Chromium, Iridium, and Tantalum, (24) Nickel, Chromium, Cobalt, and Tantalum, (25) Nickel, Platinum, Cobalt, and Tantalum, (26) Nickel, Iridium, Cobalt, and Tantalum, (27) Chromium, Platinum, and Cobalt, (28) Chromium, Platinum, and Tantalum, (29) Chromium, Iridium, and Cobalt, (30) Chromium, Iridium, and Tantalum, (31) Chromium, Cobalt, and Tantalum, (32) Chromium, Platinum, Cobalt, and Tantalum, (33) Chromium, Iridium, Cobalt, and Tantalum, (34) Platinum, Cobalt, and Tantalum, (35) Nickel and at least one element selected from the group consisting of Palladium, Rhodium, Ruthenium, Rhenium, Vanadium, Zirconium, Tungsten, Gold, Osmium, Iron, and Aluminum, (36) Chromium and Platinum, (37) Chromium and Iridium, (38) Chromium and Cobalt, (39) Chromium and Tantalum, (40) Platinum and Cobalt, (41) Platinum and Tantalum, (42) Iridium and Cobalt, (43) Iridium and Tantalum, (44) Cobalt and Tantalum, (45) Nickel, Chromium, and at least one element selected from the group consisting of Palladium, Rhodium, Ruthenium, Rhenium, Vanadium, Zirconium, Tungsten, Gold, Osmium, Iron, and Aluminum, (46) Nickel, Cobalt, and at least one element selected from the group consisting of Palladium, Rhodium, Ruthenium, Rhenium, Vanadium, Zirconium, Tungsten, Gold, Osmium, Iron, and Aluminum, (47) Nickel, Iridium, and at least one element selected from the group consisting of Palladium, Rhodium, Ruthenium, Rhenium, Vanadium, Zirconium, Tungsten, Gold, Osmium, Iron, and Aluminum, (48) Nickel, Platinum, and at least one element selected from the group consisting of Palladium, Rhodium, Ruthenium, Rhenium, Vanadium, Zirconium, Tungsten, Gold, Osmium, Iron, and Aluminum, (49) Nickel, Tantalum, and at least one element selected from the group consisting of Palladium, Rhodium, Ruthenium, Rhenium, Vanadium, Zirconium, Tungsten, Gold, Osmium, Iron, and Aluminum, (50) Chromium and at least one element selected from the group consisting of Palladium, Rhodium, Ruthenium, Rhenium, Vanadium, Zirconium, Tungsten, Gold, Osmium, Iron, and Aluminum, (51) Platinum and at least one element selected from the group consisting of Palladium, Rhodium, Ruthenium, Rhenium, Vanadium, Zirconium, Tungsten, Gold, Osmium, Iron, and Aluminum, (52) Iridium and at least one element selected from the group consisting of Palladium, Rhodium, Ruthenium, Rhenium, Vanadium, Zirconium, Tungsten, Gold, Osmium, Iron, and Aluminum, (53) Cobalt and at least one element selected from the group consisting of Palladium, Rhodium, Ruthenium, Rhenium, Vanadium, Zirconium, Tungsten, Gold, Osmium, Iron, and Aluminum, (54) Tantalum and at least one element selected from the group consisting of Palladium, Rhodium, Ruthenium, Rhenium, Vanadium, Zirconium, Tungsten, Gold, Osmium, Iron, and Aluminum, (55) Nickel, Chromium, Iridium, and at least one element selected from the group consisting of Palladium, Rhodium, Ruthenium, Rhenium, Vanadium, Zirconium, Tungsten, Gold, Osmium, Iron, and Aluminum, (56) Nickel, Chromium, Platinum, and at least one element selected from the group consisting of Palladium, Rhodium, Ruthenium, Rhenium, Vanadium, Zirconium, Tungsten, Gold, Osmium, Iron, and Aluminum, (57) Nickel, Chromium, Cobalt, and at least one element selected from the group consisting of Palladium, Rhodium, Ruthenium, Rhenium, Vanadium, Zirconium, Tungsten, Gold, Osmium, Iron, and Aluminum, (58) Nickel, Chromium, Tantalum, and at least one element selected from the group consisting of Palladium, Rhodium, Ruthenium, Rhenium, Vanadium, Zirconium, Tungsten, Gold, Osmium, Iron, and Aluminum, (59) Nickel, Platinum, Cobalt, and at least one element selected from the group consisting of Palladium, Rhodium, Ruthenium, Rhenium, Vanadium, Zirconium, Tungsten, Gold, Osmium, Iron, and Aluminum, (60) Nickel, Platinum, Tantalum, and at least one element selected from the group consisting of Palladium, Rhodium, Ruthenium, Rhenium, Vanadium, Zirconium, Tungsten, Gold, Osmium, Iron, and Aluminum, (61) Nickel, Iridium, Cobalt, and at least one element selected from the group consisting of Palladium, Rhodium, Ruthenium, Rhenium, Vanadium, Zirconium, Tungsten, Gold, Osmium, Iron, and Aluminum, (62) Nickel, Cobalt, Tantalum, and at least one element selected from the group consisting of Palladium, Rhodium, Ruthenium, Rhenium, Vanadium, Zirconium, Tungsten, Gold, Osmium, Iron, and Aluminum, (63) Chromium, Platinum, and at least one element selected from the group consisting of Palladium, Rhodium, Ruthenium, Rhenium, Vanadium, Zirconium, Tungsten, Gold, Osmium, Iron, and Aluminum, (64) Chromium, Iridium, and at least one element selected from the group consisting of Palladium, Rhodium, Ruthenium, Rhenium, Vanadium, Zirconium, Tungsten, Gold, Osmium, Iron, and Aluminum, (65) Chromium, Cobalt, and at least one element selected from the group consisting of Palladium, Rhodium, Ruthenium, Rhenium, Vanadium, Zirconium, Tungsten, Gold, Osmium, Iron, and Aluminum, (66) Chromium, Tantalum, and at least one element selected from the group consisting of Palladium, Rhodium, Ruthenium, Rhenium, Vanadium, Zirconium, Tungsten, Gold, Osmium, Iron, and Aluminum, (67) Platinum, Cobalt, and at least one element selected from the group consisting of Palladium, Rhodium, Ruthenium, Rhenium, Vanadium, Zirconium, Tungsten, Gold, Osmium, Iron, and Aluminum, (68) Iridium, Cobalt, and at least one element selected from the group consisting of Palladium, Rhodium, Ruthenium, Rhenium, Vanadium, Zirconium, Tungsten, Gold, Osmium, Iron, and Aluminum, (69) Platinum, Cobalt, and at least one element selected from the group consisting of Palladium, Rhodium, Ruthenium, Rhenium, Vanadium, Zirconium, Tungsten, Gold, Osmium, Iron, and Aluminum, (70) Chromium, Platinum, Tantalum, and at least one element selected from the group consisting of Palladium, Rhodium, Ruthenium, Rhenium, Vanadium, Zirconium, Tungsten, Gold, Osmium, Iron, and Aluminum, (71) Chromium, Iridium, Tantalum, and at least one element selected from the group consisting of Palladium, Rhodium, Ruthenium, Rhenium, Vanadium, Zirconium, Tungsten, Gold, Osmium, Iron, and Aluminum, (72) Chromium, Cobalt, Tantalum, and at least one element selected from the group consisting of Palladium, Rhodium, Ruthenium, Rhenium, Vanadium, Zirconium, Tungsten, Gold, Osmium, Iron, and Aluminum, (73) Platinum, Cobalt, Tantalum, and at least one element selected from the group consisting of Palladium, Rhodium, Ruthenium, Rhenium, Vanadium, Zirconium, Tungsten, Gold, Osmium, Iron, and Aluminum, (74) Iridium, Cobalt, Tantalum, and at least one element selected from the group consisting of Palladium, Rhodium, Ruthenium, Rhenium, Vanadium, Zirconium, Tungsten, Gold, Osmium, Iron, and Aluminum, (75) Nickel, Chromium, Platinum, Cobalt, and at least one element selected from the group consisting of Palladium, Rhodium, Ruthenium, Rhenium, Vanadium, Zirconium, Tungsten, Gold, Osmium, Iron, and Aluminum, (76) Nickel, Chromium, Platinum, Tantalum, and at least one element selected from the group consisting of Palladium, Rhodium, Ruthenium, Rhenium, Vanadium, Zirconium, Tungsten, Gold, Osmium, Iron, and Aluminum, (77) Nickel, Chromium, Platinum, Cobalt, Tantalum, and at least one element selected from the group consisting of Palladium, Rhodium, Ruthenium, Rhenium, Vanadium, Zirconium, Tungsten, Gold, Osmium, Iron, and Aluminum, (78) Nickel, Chromium, Iridium, Cobalt, and at least one element selected from the group consisting of Palladium, Rhodium, Ruthenium, Rhenium, Vanadium, Zirconium, Tungsten, Gold, Osmium, Iron, and Aluminum, (79) Nickel, Chromium, Iridium Tantalum, and at least one element selected from the group consisting of Palladium, Rhodium, Ruthenium, Rhenium, Vanadium, Zirconium, Tungsten, Gold, Osmium, Iron, and Aluminum, and (80) Nickel, Chromium, Iridium, Cobalt, Tantalum, and at least one element selected from the group consisting of Palladium, Rhodium, Ruthenium, Rhenium, Vanadium, Zirconium, Tungsten, Gold, Osmium, Iron, and Aluminum. While the above elements and alloys were listed as being added to either a firing tip having predominantly Iridium or Platinum, other firing tips with alloys instead of the Iridium or Platinum elements may be substituted. For example, a firing tip including up to 40% Rhodium, with either Iridium or Platinum, may be used with each of the elements or alloys listed above. It is also contemplated that the listed elements or alloys added to the firing tip will typically form less than 20% in total by weight of the firing tip. It is further contemplated that the above elements or alloys listed will generally form up to 10% by weight of the firing tip. More specifically, the firing tip will be typically formed out of 0.5% to 5% of one of the above alloys or elements listed. The inventors have found that the above elements or alloys tested as a firing tip provide particular resistance to corrosion as well as spark erosion in amounts of 1% to 5% and more particularly in an amount of approximately 3% by weight of the firing tip. The firing tip 30 also generally includes at least 40% and more particularly at least 50% by weight Iridium, Platinum, or combination thereof. Furthermore, the firing tip 30 includes less than 99%, more particularly less than approximately 98%, and typically more than 80%, more particularly more than 90%/, and more specifically approximately 95% of Iridium, Platinum, or combination thereof. The inventors have found that a firing tip having about 93% to 98% by weight of Iridium, Platinum, or combination thereof provides a firing tip with desirable characteristics.

The inventors have found one particular firing tip to be well suited against spark erosion and corrosion. This firing tip typically includes approximately 90% to 99% Iridium, and more particularly approximately 95% Iridium, 1% to 3% Rhodium, and more particularly approximately 2% Rhodium, 0.2% to 0.4% Tungsten, and more particularly approximately 0.3% Tungsten, 0.01% to 0.03% Zirconium, and more particularly approximately 0.02% Zirconium, and approximately 0.5% to 10%, and more particularly 0.5% to 7%, more particularly 1% to 5%, and in particular approximately 3% of one of the elements or alloys listed above (formed from at least one element selected from the group of Platinum, Chromium, Cobalt, Nickel and Tantalum.

As stated above, the firing tip includes at least one element selected from the group consisting of Cobalt, Chromium, Platinum if the firing tip is predominantly formed from Iridium, Iridium if the firing tip is predominantly formed from Platinum, Vanadium, Tantalum, or Zirconium, and more particularly, at least one element selected from the group consisting of Cobalt, Chromium, Platinum, and Tantalum for firing tips formed predominantly from Iridium. Nickel and Tungsten may also be added. The addition of these elements, solely or in combination, at least to Iridium, Platinum, or combination thereof, provides an alloy with substantial desirable characteristics for a firing tip, such as enhanced corrosion protection, enhanced spark erosion resistance, and enhanced sparking as compared with firing tips formed solely from either Nickel or Iridium.

As stated above, the firing tip 30 may include Nickel. It has been found that adding Nickel Up to 50% by weight may add desirable characteristics, before the susceptibility of Nickel to spark erosion overcomes the benefits of Nickel against corrosion. It has been found that the addition of Nickel to the firing tip 30 to form an alloy containing at least 50% by weight of Iridium and 0.5% to 50% Nickel with the addition of an element selected from the group consisting of Cobalt, Chromium, Platinum, Vanadium, Zirconium, Tantalum, and Tungsten provides excellent wear resistance, longevity, and resistance to erosion and corrosion. It has been further found that the addition of Nickel to Iridium in an amount of 0.05% to 40%, more particularly 1% to 20%, and yet more particularly 1% to 5% by weight provides excellent resistance to erosion and corrosion and increases the longevity and wear resistance of the firing tip.

When Nickel is added in an amount of 0.5% to 40% by weight to the firing tip to Iridium including at least one element selected from the group consisting of Chromium, Vanadium, Zirconium, Tantalum, Cobalt, Platinum, and Tungsten, the alloy forming the firing tip 30 has increased longevity and wear resistance as well as resistance to erosion and corrosion. More specifically it has been found that a firing tip having at least 50% Iridium, up to 20% by weight Nickel, and a substantial portion of the balance being Cobalt, Tungsten, Chromium, Vanadium, Tantalum, and Platinum provides an excellent balance of desirable characteristics. In all of the above alloys, the alloy contains at least 0.5% and more particularly at least 1% of either Cobalt, Chromium, Platinum, Nickel, Tantalum, or the combination thereof. Of course, the alloy may be further improved by the addition of Palladium, Rhodium, Ruthenium, Rhenium, Vanadium, Zirconium, and Tungsten individually or combinations thereof to improve the longevity and improve the wear resistance as well as stop erosion and corrosion that happens to pure Iridium or pure Nickel firing tips when used in spark plugs.

The spark plug may be made through any known method. The manufacture of spark plugs is typically well known including the addition of a firing tip on the center electrode and/or ground electrode. In the present invention, the firing tip can be bonded, resistance welded, laser welded, or attached through any other known method.

The spark plug 10 generally includes a metallic shell, an insulator, and a tip portion that projects from the metallic shell. The center electrode 20 is disposed in the insulator such that the firing tip 30 projects therefrom toward the ground electrode 12 which is electrically conductive with the metallic shell.

The insulator is typically formed out of Alumina and has a passage through which the center electrode 20 extends. The metallic shell is formed out of a metal in a cylindrical shape generally including the threaded portions to thread into an engine block. A resistor may be included within the passage between a terminal member and the center electrode 20.

The firing tip 30 is formed with an alloy consistent with the alloys described throughout the specification and in the claims. In forming the alloy for the firing tip 30 the alloy may be formed through any known method of forming an alloy that has substantially uniform metallic characteristics throughout. The alloy will be generally formed into metal sheets, disks, wires, or rods. One method of forming the alloy is to take individual metal powders in the desired quantities and mix. The mixture is then melted to form the alloy through a melting processing such as arc melting, beam melting, laser melting, high frequency induction melting, plasma beam melting, or any other known method and then is cooled. While the formed alloy may be preformed into the desired shape, typically a rod forming process must be carried out such as hot forming, hot rolling, or hot wire drawing. The elongated alloy is then cut to the predetermined length and the individual pieces are prepared to be attached to the center electrode 20. Of course if a disk is formed instead of a wire or rod, the alloys components may be mixed and melted and then rolled into a sheet which is pressed or punched to create the individual firing tips 30. Of course, the rod from which the firing tip is formed may first be inserted and joined to the Nickel center electrode before it is cut to length.

Once the firing tip 30 is formed it can be attached by any known method. One such method forms the firing tip by taking a rod of the alloy and forming depressions around the outer surface of the rod to create a mechanical locking mechanism. The rod is then cut to length and the center electrode is drilled out to the same diameter as the alloy rod. The tip of the alloy rod may have a similar angle to the angle of the drill point that drills out the center electrode to further secure it in place. With the alloy rod inserted into the hole in the electrode, the center electrode is then heated with a laser so that the metal of the center electrode melts around the rod and forms into the depressions formed on the outer surface of the rod.

Another method of attaching the alloy firing tip is to form a small disk of approximately 0.7 mm in diameter and 0.5 mm thick. This metal disk is then resistance welded to a cylinder of approximately the same diameter such as a cylinder formed out of approximately 80% Nickel and 20% Chromium. The disk can be formed to the center electrode by resistance welding and then laser welding to attach it. The center electrode now having the attached alloy firing tip has a head opposite the firing tip formed into a rivet shape (not shown) and then is inserted into the spark plug and resistance welded to a center wire passing through the spark plug.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A spark plug having a center electrode and a ground electrode, and wherein at least one of said center electrode and said ground electrode includes a firing tip formed from an alloy comprising:
Iridium; and
at least one element selected from the group consisting of Platinum, Chromium, Cobalt and Tantalum, said at least one element forming approximately 0.5% to 40% by weight of said firing tip.

2. The spark plug of claim 1 wherein said at least one element forms approximately 1-20% by weight of the firing tip.

3. The spark plug of claim 2 wherein said at least one element forms approximately 1-10% by weight of the firing tip.

4. The spark plug of claim 3 wherein said at least one element forms approximately 1-7% by weight of the firing tip.

5. The spark plug of claim 4 wherein said at least one element forms approximately 1-5% by weight of the firing tip.

6. The spark plug of claim 5 wherein said at least one element forms approximately 3% by weight of the firing tip.

7. The spark plug of claim 5 wherein said firing tip includes a second element selected from the group consisting of Nickel, Tantalum, Chromium, Cobalt, and Platinum.

8. The spark plug of claim 7 wherein said firing tip includes Nickel.

9. The spark plug of claim 1 wherein said at least one element is Platinum.

10. The spark plug of claim 9 wherein said firing tip further includes at least one element selected from the group consisting of Chromium, Cobalt, Nickel and Tantalum.

11. The spark plug of claim 9 wherein said firing tip includes Cobalt.

12. The spark plug of claim 9 wherein said firing tip includes Tantalum.

13. The spark plug of claim 9 wherein said firing tip further includes an element selected from the group consisting of Cobalt, Tantalum, Nickel, and Chromium.

14. The spark plug of claim 13 wherein said firing tip further includes another element selected from the group consisting of Cobalt, Tantalum, Nickel and Chromium.

15. The spark plug of claim 14 wherein said firing tip further includes an element selected from the group consisting of Palladium, Rhodium, Ruthenium, Rhenium, Vanadium, Zirconium, Tungsten, Gold, Osmium, Iron and Aluminum.

16. The spark plug of claim 14 wherein said firing tip further includes an element selected from the group consisting of Palladium, Rhodium, Ruthenium, Rhenium, Vanadium, Zirconium, Tungsten, Osmium, Iron and Aluminum.

17. The spark plug of claim 14 wherein said firing tip further includes an element selected from the group consisting of Palladium, Rhodium, Ruthenium, Rhenium, Vanadium, Zirconium, and Tungsten.

18. The spark plug of claim 14 wherein said firing tip further includes an element selected from the group consisting of Titanium, Manganese, Copper, Niobium, Molybdenum, and Yttrium.

19. The spark plug of claim 14 wherein said firing tip further includes an element selected from the group consisting of Rhodium, Tungsten, and Zirconium.

20. The spark plug of claim 1 wherein said firing tip further includes an element selected from the group consisting of Rhodium, Tungsten and Zirconium.

21. The spark plug of claim 1 wherein said firing tip further includes, Rhodium, Tungsten and Zirconium.

22. The spark plug of claim 1 wherein said firing tip further includes an element selected from the group consisting of Nickel, Iron, Manganese, and Copper.

23. The spark plug of claim 1 wherein said firing tip further includes at least two elements selected from the group consisting of Nickel, Manganese, Magnesium, Niobium, Molybdenum, and Titanium.

24. The spark plug of claim 1 wherein said firing tip further includes at least one element selected from the group consisting of Palladium, Rhodium, Ruthenium, Rhenium, Vanadium, Zirconium, Tungsten, Gold, Osmium, Iron and Aluminum.

25. The spark plug of claim 24 further including Nickel.

26. The spark plug of claim 24 further including Chromium.

27. The spark plug of claim 24 further including Cobalt.

28. The spark plug of claim 24 further including Tantalum.

29. The spark plug of claim 1 wherein said at least one element is Platinum, and said firing tip further includes Rhodium and at least one element selected from the group consisting of Nickel, Chromium, Cobalt, and Tantalum.

30. The spark plug of claim 1 wherein said firing tip further includes at least two elements selected from the group consisting of Nickel, Cobalt, Chromium, Platinum, and Tantalum and wherein said at least two elements are different than said at least one element.

31. The spark plug of claim 1 wherein said at least one element is Cobalt and said firing tip further includes Nickel, and at least one element selected from the group consisting of Chromium, Platinum and Tantalum.

32. The spark plug of claim 1 wherein said at least one element is Tantalum and said firing tip further includes Nickel, and at least one element selected from the group consisting of Chromium, Platinum and Cobalt.

33. The spark plug of claim 1 wherein said firing tip further includes Rhodium.

34. The spark plug of claim 1 wherein said at least one element is selected from the group consisting of Tantalum, Platinum and Cobalt, and said at least one element forms approximately 0.5% to 10% by weight of said firing tip.

35. The spark plug of claim 1 wherein said at least one element is selected from the group consisting of Tantalum and Cobalt.

36. A spark plug having a center electrode and a ground electrode and wherein at least one of said center electrode and said ground electrode includes a firing tip formed from an alloy comprising:
at least one element selected from the group consisting of Iridium and Platinum; and
at least one element selected from the group consisting of Rhodium, Chromium, Cobalt and Tantalum, said at least one element forming approximately 0.5% to 40% by weight of said firing tip.

37. The spark plug of claim 36 wherein said at least one element selected from the group consisting of Iridium and Platinum is Iridium and wherein said at least one element selected from the group consisting of Rhodium, Chromium, Cobalt and Tantalum is Rhodium, and wherein said firing tip further includes at least one element selected from the group consisting of Nickel, Chromium, Platinum, Cobalt and Tantalum.

38. The spark plug of claim 37 wherein said at least one element selected from the group consisting of Nickel, Chromium, Platinum, Cobalt and Tantalum is Nickel.

39. The spark plug of claim 37 wherein said at least one element selected from the group consisting of Nickel, Chromium, Platinum, Cobalt and Tantalum is Cobalt.

40. The spark plug of claim 37 wherein said at least one element selected from the group consisting of Nickel, Chromium, Platinum, Cobalt and Tantalum is Tantalum.

41. The spark plug of claim 37 wherein said at least one element selected from the group consisting of Nickel, Chromium, Platinum, Cobalt and Tantalum is Chromium.

42. The spark Plug of claim 37 further including at least one element selected from the group consisting of Palladium, Ruthenium, Rhenium, Vanadium, Zirconium, Tungsten, Gold, Osmium, Iron and Aluminum.

43. The spark plug of claim 36 wherein said at least one element selected from the group consisting of Iridium and Platinum is Iridium and wherein said at least one element selected from the group consisting of Rhodium, Chromium, Cobalt and Tantalum is Rhodium, and wherein said firing tip further includes at least two elements selected from the group consisting of Nickel, Chromium, Platinum, Cobalt and Tantalum.

44. The spark plug of claim 36 further including at least two elements selected from the group consisting of Nickel, Chromium, Cobalt, Tantalum, Palladium, Ruthenium, Rhenium, Vanadium, Zirconium, Tungsten, Gold, Osmium, Iron and Aluminum

45. The spark plug of claim 36 wherein said at least one element selected from the group consisting of Iridium and Platinum is Iridium and wherein said at least one element selected from the group consisting of Rhodium, Chromium, Cobalt and Tantalum is Rhodium, said Rhodium forming up to 40% by weight of the firing tip and wherein said firing tip further includes at least one elements selected from the group consisting of Nickel, Platinum, Chromium, Cobalt and Tantalum, said at least one element forming approximately 0.5% to 20% of the firing tip and wherein Iridium forms approximately the balance of the firing tip by weight.

46. The spark plug of claim 45 wherein said at least one element selected from the group consisting of Nickel, Platinum, Chromium, Cobalt and Tantalum forms approximately 0.5% to 20% by weight of the firing tip.

47. The spark plug of claim 46 wherein said at least one element selected from the group consisting of Nickel, Platinum, Chromium, Cobalt and Tantalum forms approximately 0.5% to 10% by weight of the firing tip.

48. The spark plug of claim 47 wherein said at least one element selected from the group consisting of Nickel, Platinum, Chromium, Cobalt and Tantalum forms approximately 0.5% to 5% by weight of the firing tip.

49. The spark plug of claim 48 wherein said at least one element selected from the group consisting of Nickel, Platinum, Chromium, Cobalt and Tantalum forms approximately 0.5% to 3% by weight of the firing tip.

50. The spark plug of claim 48 wherein said at least one element selected from the group consisting of Nickel, Platinum, Chromium, Cobalt and Tantalum forms approximately 1% to 5% by weight of the firing tip.

51. The spark plug of claim 50 wherein said at least one element selected from the group consisting of Nickel, Platinum, Chromium, Cobalt and Tantalum forms approximately 3% by weight of the firing tip.

52. The spark plug of claim 36 wherein said at least one element selected from the group consisting of Iridium and Platinum is Iridium and wherein said Iridium forms at least 50% by weight of the firing tip.

53. The spark plug of claim 52 wherein said Iridium forms at least 90% by weight of the firing tip.

54. The spark plug of claim 53 wherein said Iridium forms approximately 93% to 99% by weight of the firing tip.

55. The spark plug of claim 37 wherein said at least one element selected from the group consisting of Nickel, Chromium, Platinum, Cobalt and Tantalum is Platinum.

56. A spark plug having a center electrode and a ground electrode, and wherein at least one of said center electrode and said ground electrode includes a firing tip formed from an alloy comprising:
Iridium in an amount of 50% to 99% by weight of the firing tip;
Rhodium in an amount of approximately 0.5% to 5% by weight of the firing tip;
Tungsten in an amount of approximately 0.1% to 0.5% by weight of the firing tip;
Zirconium in an amount of less than approximately 0.1% by weight of the firing tip; and
at least one element selected from the group consisting of Platinum, Chromium, Cobalt, Nickel and Tantalum.

57. The spark plug of claim 56 wherein said firing tip further includes another element from the group consisting of Platinum, Chromium, Cobalt, Nickel and Tantalum.

58. A spark plug having a center electrode and a ground electrode, and wherein at least one of said center electrode and said ground electrode includes a firing tip formed from an alloy comprising:
Iridium;
at least two elements selected from the group consisting of Rhodium, Tungsten, and Zirconium; and
at least one element selected from the group consisting of Platinum, Chromium, Cobalt, Nickel and Tantalum.

59. The spark plug of claim 58 wherein said at least one element selected from the group consisting of Platinum, Chromium, Cobalt, Nickel and Tantalum, forms approximately 0.5% to 40% by weight of the firing tip.

60. The spark plug of claim 59 wherein said at least one element selected from the group consisting of Platinum, Chromium, Cobalt, Nickel and Tantalum, forms approximately 0.5% to 20% by weight of the firing tip.

61. The spark plug of claim 60 wherein said at least one element selected from the group consisting of Platinum, Chromium, Cobalt, Nickel and Tantalum, forms approximately 0.5% to 10% by weight of the firing tip.

62. The spark plug of claim 61 wherein said at least one element selected from the group consisting of Platinum, Chromium, Cobalt, Nickel and Tantalum, forms approximately 1% to 5% by weight of the firing tip.

63. The spark plug of claim 62 wherein said at least one element selected from the group consisting of Platinum, Chromium, Cobalt, Nickel and Tantalum, forms approximately 3% by weight of the firing tip.

64. The spark plug of claim 58 wherein said at least one element selected from the group consisting of Platinum, Chromium, Cobalt, Nickel and Tantalum is Platinum.

65. The spark plug of claim 64 further including at least one element selected from the group consisting of Chromium, Cobalt, Nickel and Tantalum.

66. The spark plug of claim 65 further including a second element selected from the group consisting of Chromium, Cobalt, Nickel and Tantalum.

67. The spark plug of claim 58 wherein said at least one element selected from the group consisting of Platinum, Chromium, Cobalt, Nickel and Tantalum is Nickel.

68. The spark plug of claim 67 further including at least one element selected from the group consisting of Platinum, Chromium, Cobalt and Tantalum.

69. The spark plug of claim 68 wherein said at least one element selected from the group consisting of Platinum, Chromium, Cobalt, Nickel and Tantalum is Cobalt.

70. The spark plug of claim 68 wherein said at least one element selected from the group consisting of Platinum, Chromium, Cobalt, Nickel and Tantalum is Tantalum.

71. The spark plug of claim 58 further including at least one element selected from the group consisting of Platinum, Chromium, Cobalt, and Nickel.

72. The spark plug of claim 58 wherein Rhodium forms approximately 1-40% by weight of the firing tip.

73. The spark plug of claim 72 wherein Rhodium forms approximately 1-3% by weight of the spark plug.

74. The spark plug of claim 58 wherein Tungsten forms approximately 0.1% to 1% by weight of the firing tip.

75. The spark plug of claim 58 wherein Iridium forms 90% to 98% by weight of the firing tip.
